(19) United States
(12) Patent Application Publication
(10) Pub. No.: US 2016/0132476 A1
(43) Pub. Date: May 12, 2016

(54) GUIDANCE CONTENT DEVELOPMENT AND PRESENTATION

(71) Applicant: Vinc Corporation, San Diego, CA (US)

(72) Inventors: Gordon Scott SCHOLLER, Providence, RI (US); Ronen Zeev LEVY, Corona, CA (US); Zahi Itzhak SHIRIZLI, La Jolla, CA (US)

(73) Assignee: Vinc Corporation, San Diego, CA (US)

(21) Appl. No.: 14/934,674

(22) Filed: Nov. 6, 2015

Related U.S. Application Data
(60) Provisional application No. 62/076,399, filed on Nov. 6, 2014.
(60) Provisional application No. 62/076,414, filed on Nov. 6, 2014.

(51) Int. Cl. G06F 17/24; G06F 3/0484; G06F 3/0482; G06F 17/22

(52) U.S. Cl. CPC G06F 17/24; G06F 17/2235; G06F 17/2205; G06F 3/04842; G06F 3/0482

(57) ABSTRACT

An adaptive content system may include a storage system, a development module, and a presentation module. The storage system may store populated and unpopulated content units configured to contain information content and at least one sequence link selectable by a user for establishing a sequence in which the content units are presented to a user. The development module may populate or modify a stored content unit. The presentation module may access the storage system to retrieve content units for presentation on an output device in response to inputs received from an input device without allowing modification of the information content populated on the content units.

### RELATED APPLICATIONS

This application claims the benefit of U.S. Provisional Application No. 62/076,399, filed Nov. 6, 2014, and U.S. Provisional Application No. 62/076,414, filed Nov. 6, 2014, which applications are incorporated herein by reference in their entirety for all purposes.

This application is related U.S. patent application Ser. No. 14/934,635, filed by the same applicant on the same day as this application is being filed, Nov. 6, 2015, and having the title USER-DIRECTED INFORMATION CONTENT, which application is incorporated herein in its entirety for all purposes.

### FIELD

This disclosure relates to information content navigation. More specifically, the disclosed embodiments relate to systems and methods for user-directed navigating through information content in a presentation.

### BACKGROUND

A learner may require guidance in learning a process, procedure, or topic. For example, a student may require guidance in learning scholastic topics. As another example, a user of an unfamiliar product may need guidance on proper assembly, installation, or use of such product. Typically, guidance is delivered via media information appropriately selected, segmented, configured, sequenced and/or presented by an expert. An expert can deliver guidance to a learner via personal tutoring and/or prerecorded instructions, for example. Prerecorded instructions and information presentations are statically presented without awareness of a particular learner's understanding.

### SUMMARY

Apparatus and methods may provide user-driven information-content presentations. In some embodiments, an adaptive content system may include a storage system, a development module, and a presentation module. The storage system may include at least one storage device. The storage system may store at least one unpopulated content unit having selectable fields configured to receive information content presentable in a form sensible to a user and configured to receive sequence links to at least one other content unit. The storage system may further store at least one content collection. Each content collection may include a plurality of populated content units. Each populated content unit may contain information content and at least one sequence link selectable by a user for establishing a sequence in which the content units are presented to a user. The development module may be configured to access the storage system to retrieve a copy of the at least one unpopulated content unit, to populate the copy of the at least one unpopulated content unit with information content received from an author on at least one development input device, to retrieve a populated content unit selected by the author, to modify the information content in the selected populated content unit in response to commands received on the at least one development input device, and to store populated content units on the storage system. The presentation module may be configured to access the storage system to retrieve the at least one content collection of content units, to present on at least one presentation output device content units sequentially in response to inputs received from at least one user-operated presentation input device, and to present on the at least one output device information content from the presented content units in response to inputs received from the at least one user-operated presentation input device without allowing modification of the information content populated on the content units.

Features, functions, and advantages may be achieved independently in various embodiments or may be combined in yet other embodiments, further details of which can be seen with reference to the following description and drawings.

### BRIEF DESCRIPTION OF THE DRAWINGS

FIG. 1 is a schematic diagram of an exemplary data processing system that may be configured as an adaptive content system.

FIG. 2 is an illustration of the display of a first example of an unpopulated content unit.

FIG. 3 is an illustration of the display of the content unit of FIG. 2 partially populated.

FIG. 4 is an illustration of an example of accessing a next-sequential unpopulated control unit in the form of a scene.

FIG. 5 shows an example of a general representation of a series of content units in the form of scenes prepared using a development module.

FIG. 6 is an illustration of the display of an example of accessing an unpopulated content unit, referred to as a response template, from a scene.

FIG. 7 is an illustration of the display of a second example of a partially populated scene indicating associated scene responses.

FIG. 8 is an illustration of the display of a list of responses displayed in response to an author input.

FIG. 9 is an illustration of the display of accessing a content unit in the form of a response accessed from a sequentially previous response.

FIG. 10 is an example of a user-navigation map illustrating representative sequence links between content units in a collection of content units.

FIG. 11 is a schematic diagram of an exemplary data processing system that may be configured as an adaptive content system.

FIG. 12 is a schematic representation of an illustrative computer network system that also may be configured as an adaptive content system.

### DESCRIPTION

In general, information may be provided by a presenter to one recipient or more than one recipient via a collection of content units. A collection of content units may provide information to a student on a scholastic topic. As another example, a collection of content units such as a user-guide may be directed to instructing a user of the device conveying the collection of content units how to complete a task. A collection of content units that presents steps or procedures for completing one or more tasks may be referred to as guidance content.

Such guidance content may convey the information using a vehicle of expression that includes one or a combination of text, audio, images, animations, video, interactive media, etc. For example, information may be presented via a computing device such as a tablet pc, desktop computer, or mobile smart phone to a user operating the computing device. Collections of content units provided on a computing device may be accessed by a user over a network, such as the Internet. In such a case, webpages may be accessed progressively by links embedded in the webpages, rather than merely listing or providing content on a single, extended webpage. Such website-based collections of content units may be defined by what is commonly known as a “site map”.

Guidance content may be produced in various ways. As an example, a collection of content units may be prepared by a developer or author using a software-based development module that provides the author with tools for preparing content to be provided to a user. For example, a development module running on a computing device may provide a graphical user interface providing text entry fields, media selection boxes, and/or audio and/or video recording or selection modules. Such content may be selectively accessed by the user of the computing device by operation of a touch screen display, keyboard, and/or dedicated cursor control device, such as a mouse.

It may be desirable for an author of a collection of content units to have access to information about usage of the collection of content units. Usage information may be input by a user via a computing device running the collection of content units. For example, usage information may include user keystrokes, navigation paths selected by users, time spent viewing particular sections of the collection of content units, user performance, and user feedback. Having access to both usage information and user feedback, an author may learn how a collection of content units is used, and consider changes to improve the collection of content units. For example, an author of a collection of content units may identify problematic segments of the collection of content units and provide more effective content via an updated collection of content units. Such a collection of content units may be updated via a development interface as discussed generally above and specifically below. As such, collections of content units may be updated and/or improved in consideration of usage information provided by a user. Further, a collection of content units running on a network connected computing device may provide real time user input feedback accessible by an author, ultimately resulting in richer, more effective collections of content units.

Embodiments are disclosed herein that relate to an adaptive guidance content system for composing, distributing and updating collections of content units. Such a system is particularly beneficial for the production and maintenance of guidance content. Although the following discussion is directed to an adaptive content system for producing and maintaining guidance content, the features and principles may also be applied to other subject matter.

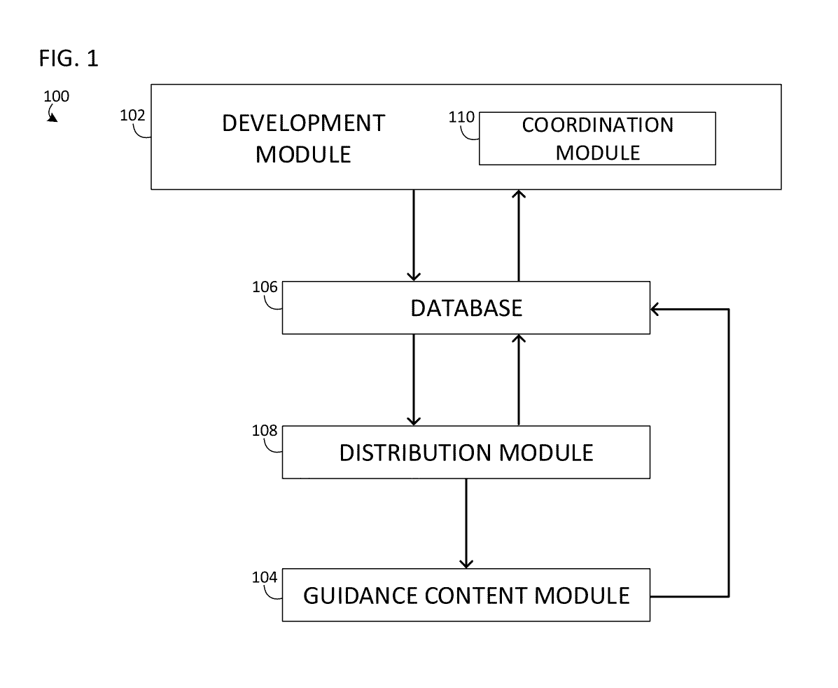

FIG. 1 shows an overview of elements of one example of an adaptive content system 100. Adaptive content system 100 may include a development module 102 for composing guidance content that may be ultimately accessed by a guidance content module 104, an example of a presentation module, for presentation to a recipient. Guidance content composed via development module 102 may be provided to guidance content module 104 via database 106 and distribution module 108. For example, guidance content may be stored in a development section of the database.

When guidance content is complete it may be migrated to a distribution section of the database. Development module 102 may be used to compose guidance content, and then send them to database 106. It will be appreciated that the development and distribution sections of the database may be sections of a common database or they may be separate databases. A recipient running guidance content module 104 may access or otherwise download guidance content from the distribution section of the database 106 via distribution module 108. Once accessed or downloaded, guidance content module 104 may run or execute the accessed guidance content. Guidance content module 104 may send to the development section of the database, information related to use of the accessed guidance content, such data being accessible by development module 102

The development module may include, or may interface with a coordination module 110 that may facilitate coordination and collaboration between authors. For example, coordination module 110 may include a coordination interface that allows authors to communicate with each other. Such a coordination interface may include team authoring tools that further include one or more tools described herein. Coordination interface may include any suitable tool that enables authors to work together on authoring collections of content units.

In a preferred embodiment, development module 102 provides an author with tools for composing guidance content. For example, guidance content may have characteristics described in my copending U.S. provisional application filed on the same date as this application and titled “USER-DIRECTED GUIDANCE CONTENT.” Such guidance content may include guidance content pages or content units in the form of scenes, responses, and titles. Scenes may have links to other pages in the guidance content, user text entry fields, or other forms of content as described in the referenced application.

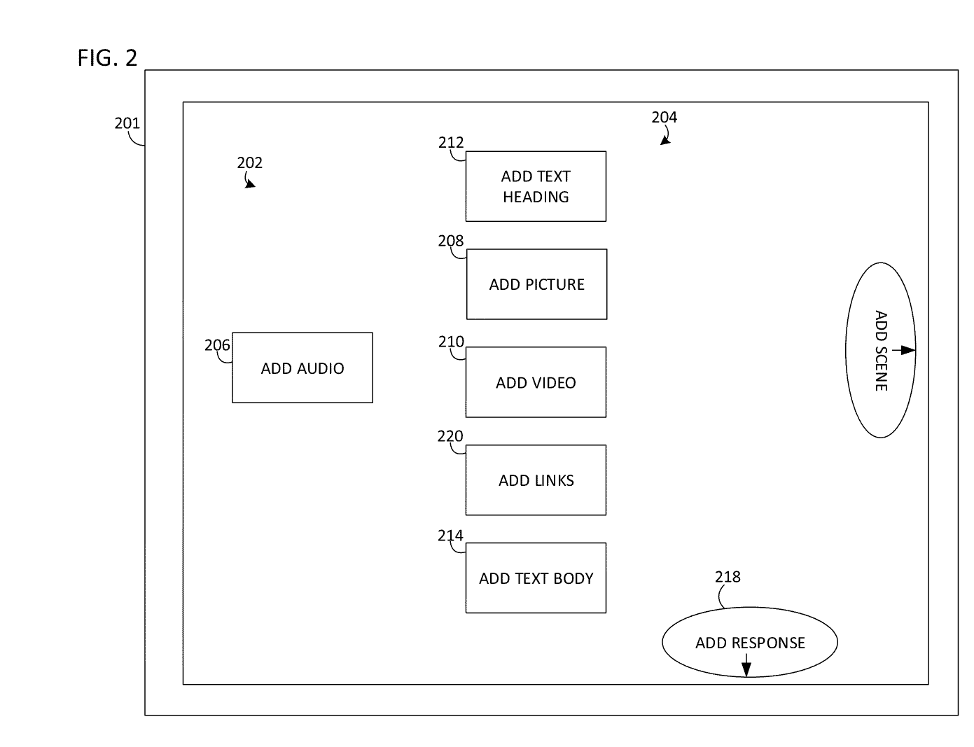

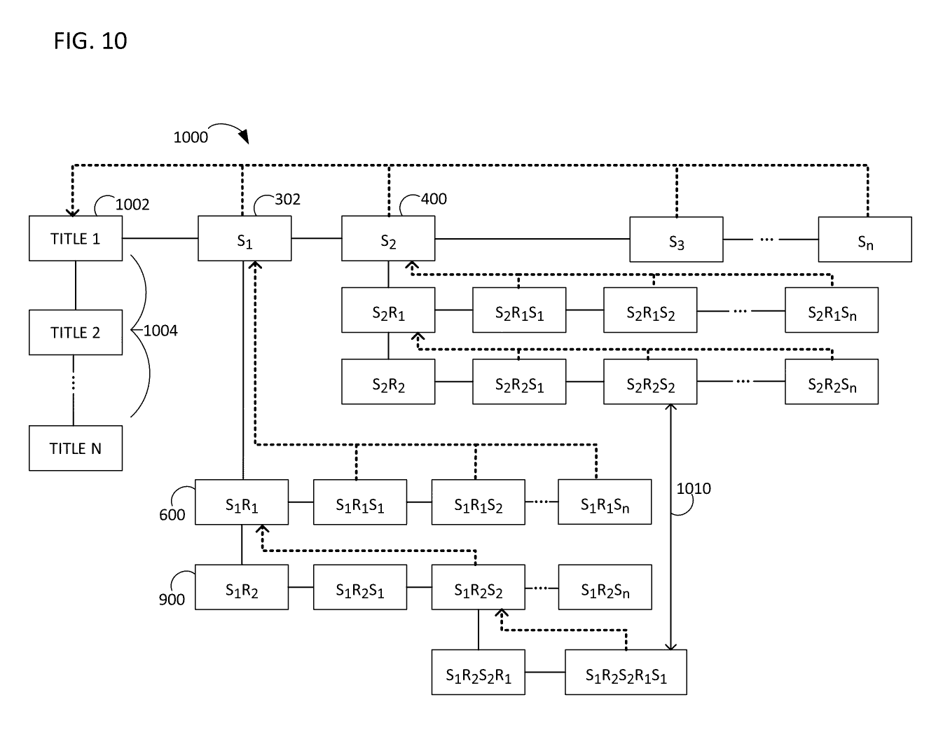

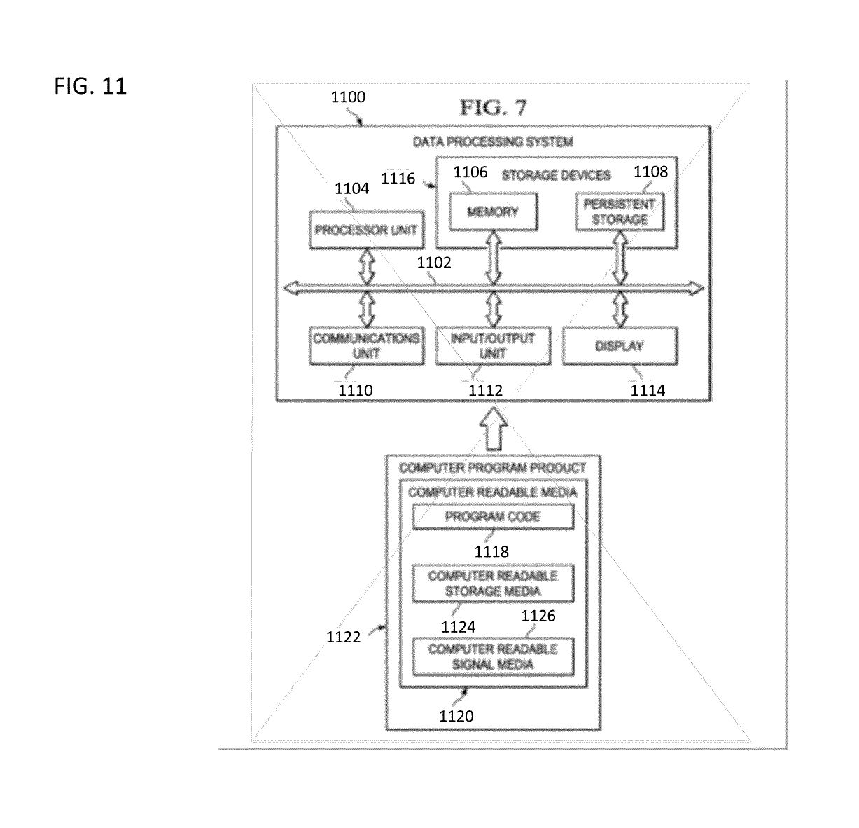

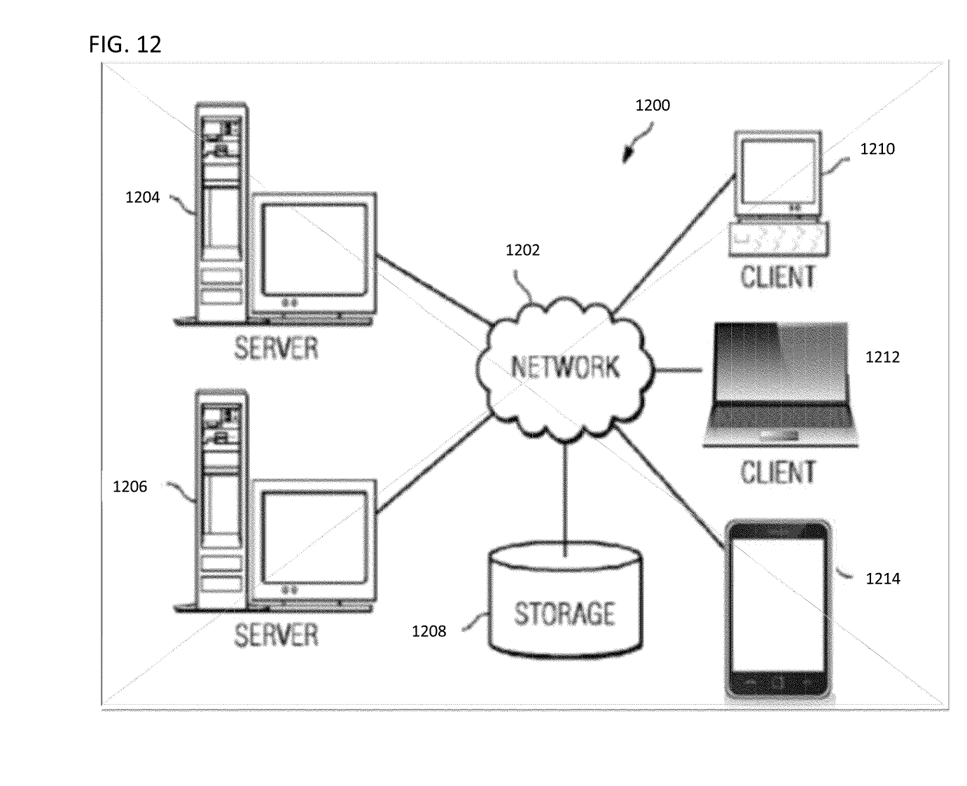

FIG. 2 illustrates an example of a development interface 200 of a presentation module that may be an interactive display of an unpopulated content unit in the form of a scene template 202 that may be used in the development module to produce a scene of guidance content. Development interface 200 is displayed via a display 201 of an appropriate computing device, such as display 1114 of FIG. 10 further described below. As discussed further below, development interface 200 may also be selectively configured to display a content unit in the form of a response template, as discussed further below. Development interface 200 may be presented to an author via any appropriate device, such as a local or otherwise partially or completely network-based computing device running the presentation module. For example, an appropriate computing system and a network are shown in FIGS. 11 and 12, respectively. Computing devices may include tablet pc's, laptops and desktop computers. Development interface 200 provides to an author development tools 204 for composing one or more guidance content pages or content units of guidance content. For example, when a scene template is displayed, a scene may be produced that provides information to a user of guidance content module 104 using one medium or more than one medium, referred to generally as media content. A scene may include a single medium for presentation or may involve interactive or selectively actuatable media, such as interactive buttons, text entry fields, or selectable links for activating different media. A scene may include more than one occurrence of a given type of media, each with different content or a different form of the same content, or similar content may be provided by each of different types of media.

Examples of selectable media content may include audio, video, text, and/or images. Accordingly, scene development tools may include an audio tool 206 that may provide for recording an audio file or selecting a prerecorded audio file to link to the scene. An image or picture tool 208 may be used to import a stored picture file into the scene so that it is visible with the scene. A video tool 210 may be used to add to the scene a link to a video file and video player application to enable a recipient to view the video by selecting the link. Additionally, video tool 210 may be used to add a video file that is automatically played to a recipient via guidance content module 104. Video files added via video tool 210 may be provided to guidance content module 104 in any appropriate way that allows a recipient to view the video files. Limited text, such as a heading or subtitle, may be added to the scene using a limited-text field tool 212. More extensive text may be added to the scene by an extended-text tool 214 that may allow entry of the text using a virtual or real keyboard, importing the text from a file or the computer clipboard, or providing a link to a document that may be viewed. An author may provide links in the scene to other pages of the guidance content using a links tool 216 For example, the links may be named as choices that a recipient may select.

In addition to selecting the content of a scene, a scene may be directly associated with or linked to additional pages of the guidance content. For example, a response-linking tool 218 may allow the author to create one or more responses that may relate to the content provided in a base scene. A response page may add more detailed information regarding the content provided in the base scene. As is discussed further below, each response may have none, one, or more scenes that are accessible to the recipient via the response. Additionally, the author may compose additional scenes accessible directly from a base scene using a scene linking tool 220, also discussed further below.

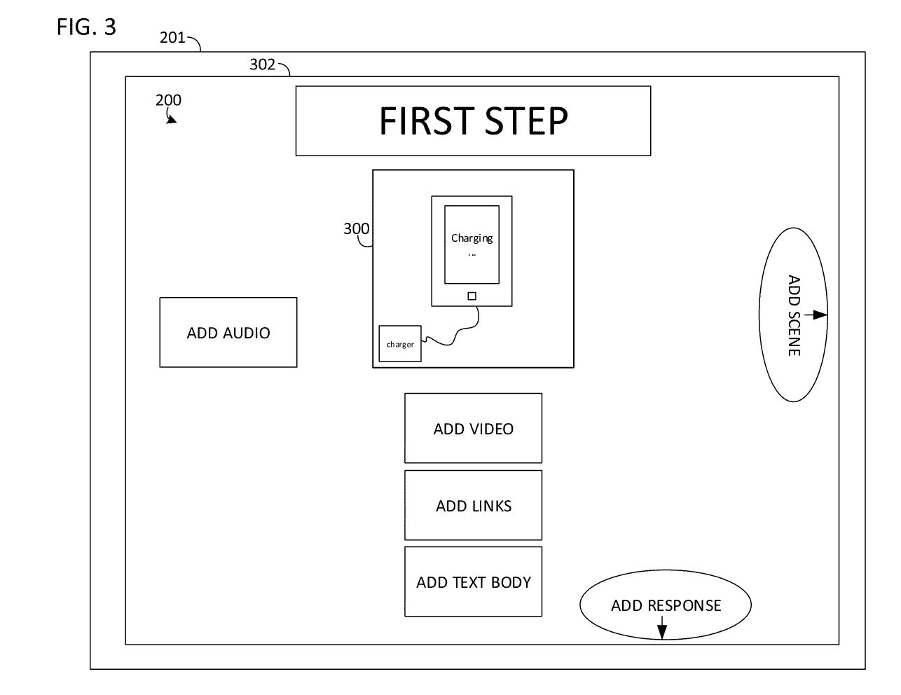

In composing a scene, an author may select a type of media content to add using one of various known selection techniques, such as tapping a touch screen display or positioning a cursor over a media selection field using a cursor control device, such as a mouse, and clicking on the field. For example, an author may select picture tool 208, which allows selection and placement in the scene of one or more images to be displayed to a user, such as a selected image 300 shown in FIG. 3. As another example, an author may enter a limited amount of text by selecting limited-text field tool 212 or extended-text tool 214 of FIG. 2, and entering selected text on a keyboard, such as entering the phrase “STEP ONE” in the text field as shown in FIG. 3. As such, scene template 202 allows an author to compose scene 302 of FIG. 3.

The media added to a scene by an author may be positioned in the scene using known techniques used for handling touch screen displays and mouse controls relating to cursors. For example, zooming in or out may be accomplished via an author pinching or otherwise spreading their fingers on a touch screen display. As another example, pausing a streaming video may be accomplished via an author tapping the video image displayed on a touch screen display. Likewise, guidance content module 104 may allow a recipient to use guidance content via common touch screen handling techniques or mouse cursor controls. Further, guidance content module 104 may provide to a recipient a same set of control or handling techniques as those provided by development module 102 to an author.

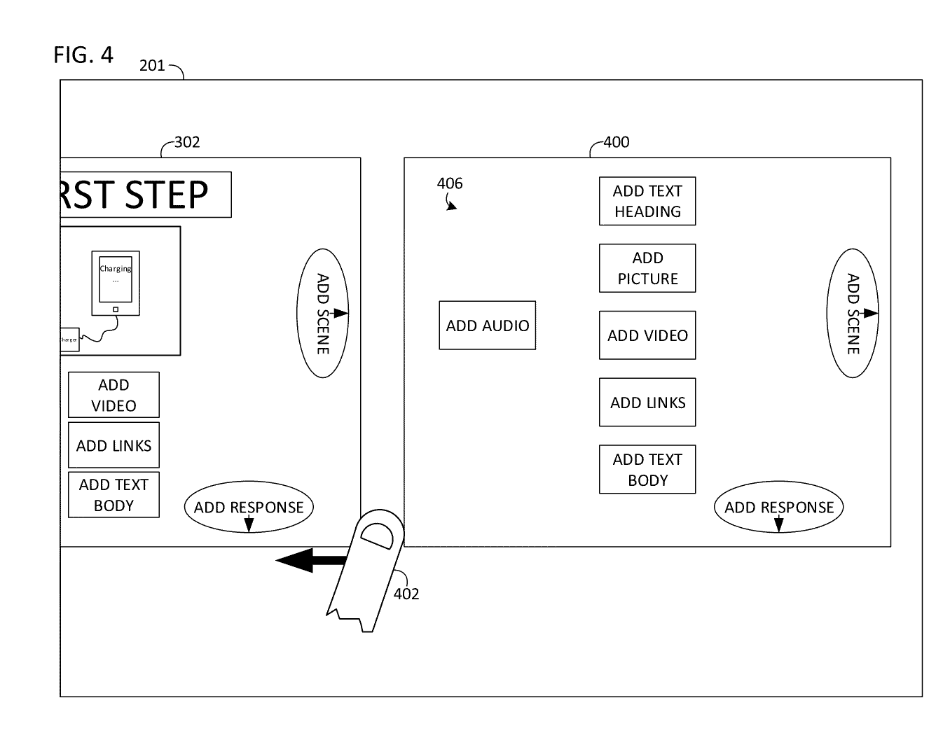

Once a scene has been composed, an author may then add responses linked to the scene, or may add one or more additional scenes that are to be displayed serially as a sequence. Development interface 200 may allow an author to add one or more scenes to an existing scene or response at any time after the existing scene or response is assigned some content. For example, FIG. 4 shows an author adding an adjacent scene 400 by providing author input 402 in the form of a right-to-left swipe of the display when the existing scene is displayed. As another example, an author may add a scene by clicking a mouse pointer on a selectable virtual “add scene” button 404. Author input 402 may be applied in any suitable way established for the particular development module, such as by clicking and/or dragging a mouse pointer, expressing voice commands, selecting a display transition with an electronic stylus, or entering a command using a keyboard.

After an author indicates that a new scene is to be added, development interface 200 may display a new scene template 406. New scene template 406 may be identical or to scene template 202 of FIG. 2, in which content may be added using one or more development tools of a pre-defined set of development tools. Alternatively, in response to an author requesting the adaptive content system to add a scene, the author may be prompted by the adaptive content system to choose a scene template. Alternatively, an author may manually select a scene template to be used in composing an instant or next scene. It is to be understood that development interface 200 may add scenes to guidance content in any order, with the sequence of scenes being adjustable prior to finalizing the guidance content for distribution. For example, development interface 200 may allow an author to add a scene that is not adjacent to a currently developed scene. As another example, an author may conveniently drag and drop scenes as desired such as by accessing a list of guidance content pages and the relationships between the pages, or by using an overview of the guidance content as shown in FIG. 10, discussed below. In any case, development interface allows an author to add further scenes and rearrange scenes using appropriate author inputs.

Content included in an adjacent, sequentially subsequent scene may be progressively related to a previous scene. For example, an adjacent second scene may provide a next segment of information related to information provided in an adjacent first or sequentially prior scene.

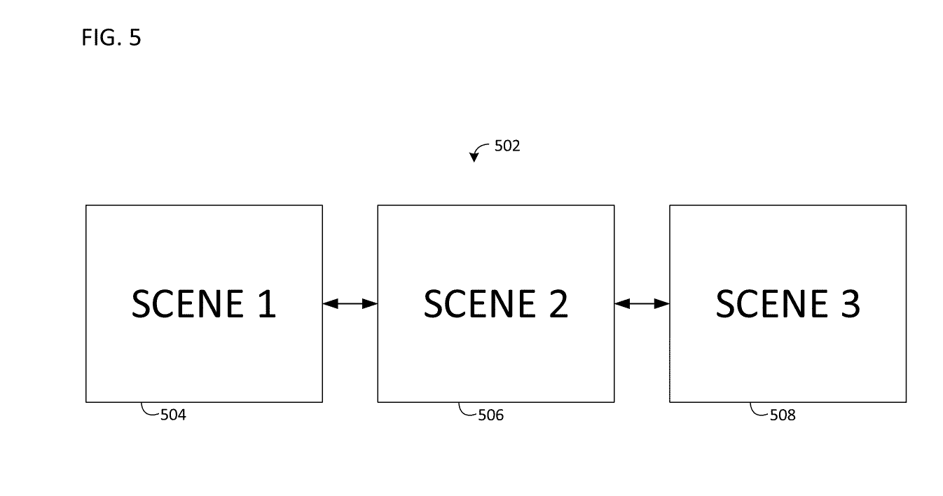

FIG. 5 shows an example of guidance content 500 providing a series of scenes 502, prepared using development module 102. When executed or run by guidance content module 104, scene 504, scene 506, and scene 508 of series of scenes 502 may be sequentially navigated by a user. For example, a user viewing scene 504 may navigate to adjacent scene 506 by swiping a touch screen display from right to left (i.e. leftward) with a user's finger. Further, the user may swipe again in the same direction to navigate to and display scene 508. A user may navigate to a previous scene by providing a directionally opposite user input. For example, a user may navigate to the sequentially previous scene by swiping the touch screen display from left to right (i.e. rightward). A more detailed description of guidance content, relationships between guidance content pages by content and access proximity, and how a user may navigate between the pages is provided in my copending U.S. provisional application filed on the same date as this application and titled “USER-DIRECTED GUIDANCE CONTENT,” which application is incorporated herein by reference.

The development module and the guidance content module may be configured to allow an author or a guidance content recipient or user to navigate to adjacent guidance content pages using any of several different types of author or user input, as has been described. In some examples, an author or user may navigate to adjacent guidance content pages in a directionally intuitive way. Guidance content pages displayable by the development and guidance content modules may include any feature or features that may be used to present content or navigate from one guidance content page to another. Further, input commands for author inputs in development module 102 and user inputs in guidance content module 104 may be substantially the same. For example, swiping a finger across a touch screen to access a new scene template in development module 102 may be the same motion as is used in navigating to a next scene in guidance content module 104.

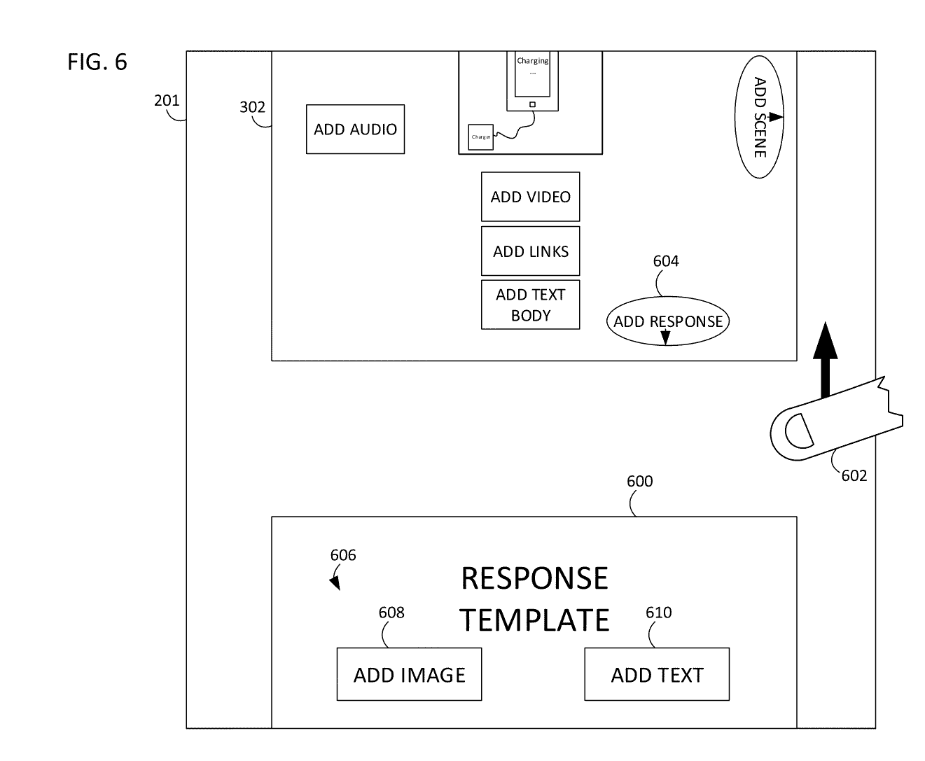

FIG. 6 illustrates adding a scene response 600 to base scene 302 of FIG. 3 in response to an author input 602 applied to development interface 200. FIG. 6 illustrates scene 302 being a base scene of scene response 600. An author input for adding a scene response may be a swiping gesture on a touch screen display, for example. Alternatively, an author input for adding a scene response may include tapping or clicking a virtual button, such as add scene response button 604. FIG. 6 illustrates development interface 200 providing a response template 606 for composing a scene response in response to author input 602. Author input 602 for adding a scene response and/or accessing response template 606 may be directionally perpendicular or otherwise transverse to author input 402 of FIG. 4 for accessing new scene template 406. For example, an author input for accessing a response template may be a vertical gesture and an author input for accessing a new scene template may be a horizontal gesture. In particular, author input 602 may consist of swiping from down to up (i.e. upward) while viewing composed scene 302 or a previously composed scene response in development interface 200. Additional corresponding author inputs such as author inputs directionally similar to author input 602 or additional clicks or taps on add scene response button 604, may add further scene responses. Author input 602 or add scene response button 604 may be used to add one of a plurality of scene responses related to and providing further detail or information related to the content in base scene 302 that will assist a user in understanding the subject matter of the content in base scene 302. In some examples, a scene may have only one associated scene response or even no associated scene responses. Guidance content may be produced by development module 102 so that after receiving content in scene 302, a user of guidance content module 104 needing further information regarding the scene content may provide a user input that requests that a scene response be displayed.

Responses associated with a scene may provide further information about the scene. In this regard FIG. 6 illustrates a response template 606 that an author may use to compose a scene response linked to base scene 302. Scene response template 606 may include selectable response development tools for adding media content to the scene response, such as audio, video, text, and/or images. In this example, the response development tools may include an image or picture tool 608 for importing a stored picture file into the scene response so that it is visible with the scene response. A text tool 610 may be used to add and format text to be displayed as part of the scene response. It is to be understood that adding a scene response may be accomplished by inputting any of the available forms of content.

A user may continue swiping in the same direction to display any additional scene responses related to the associated base scene. Accordingly, development module 102 may allow an author to add one or more scene responses that are then associated with the base scene by providing an appropriate author input.

A scene response may be associated with a particular base scene and may be a guidance content page that provides further detail on or elaboration of information provided in the associated base scene. For example, a scene response to a base scene about charging a mobile phone battery may provide further detail about a charge indicator light. A scene may have no responses, one response, or a series of responses associated with it. A response, in turn, may have no response scene, one response scene, or a series of response scenes associated with and accessed from the associated scene response.

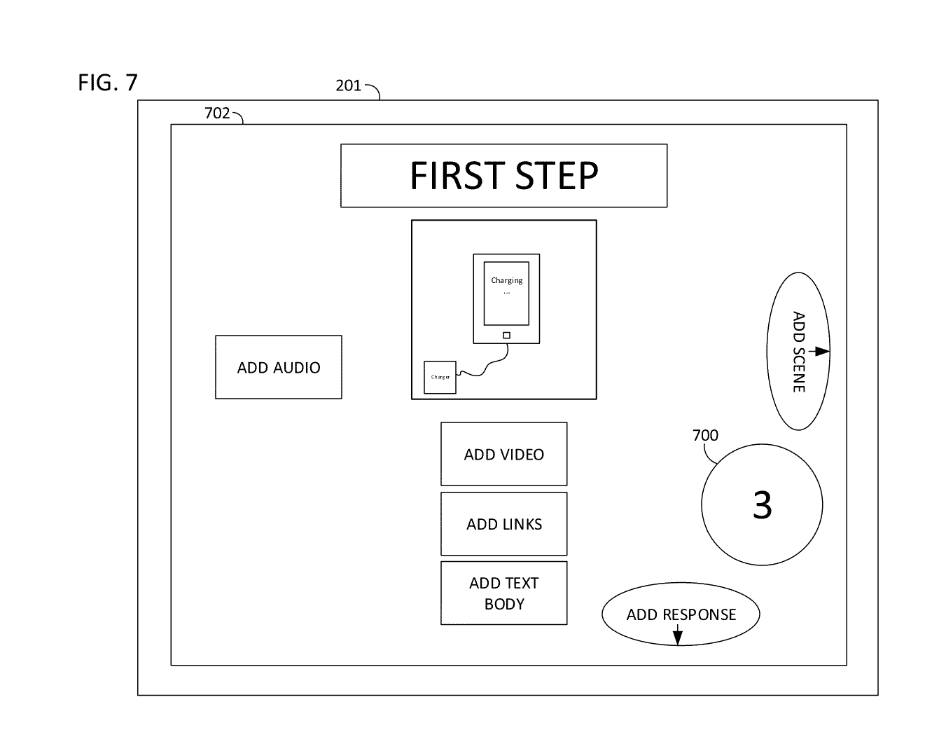

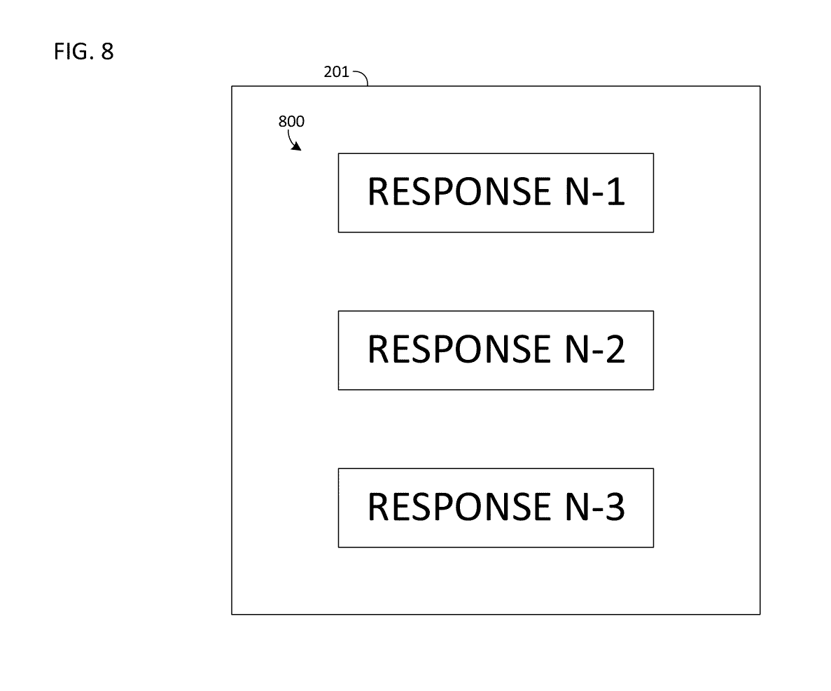

Alternatively or additionally, the scene template of the development module may allow an author to add or include a virtual interactive button that displays a number of scene responses related to a particular scene. An example of such an interactive button is shown in FIG. 7 as interactive button 700 indicating in a base scene 702 that three scene responses are available for further information. Interactive button 700 may be selectable from a scene template, it may be produced automatically based on the number of scene responses added to the base scene, or it may be added or composed by an author using editing features provided in the development module. Once scene responses are composed, an author of guidance content module 104 may activate or select such an interactive button via a user input, resulting in the display of the indicated one or more scene responses in a list, such as scene response list 800 shown in FIG. 8. Once displayed in a list, the one or more scene responses may be selectable via an additional author input. Selection of a scene response by a cursor control device or screen touch may cause the selected scene response to be displayed. It is to be understood that interactive button 700 of FIG. 7 may take any suitable form selectable to provide a user or an author with access to response list 800 and/or another indication of available scene responses. Alternatively, interactive button 700 may instead merely indicate a number of scene responses related to a particular scene without being interactive or selectable.

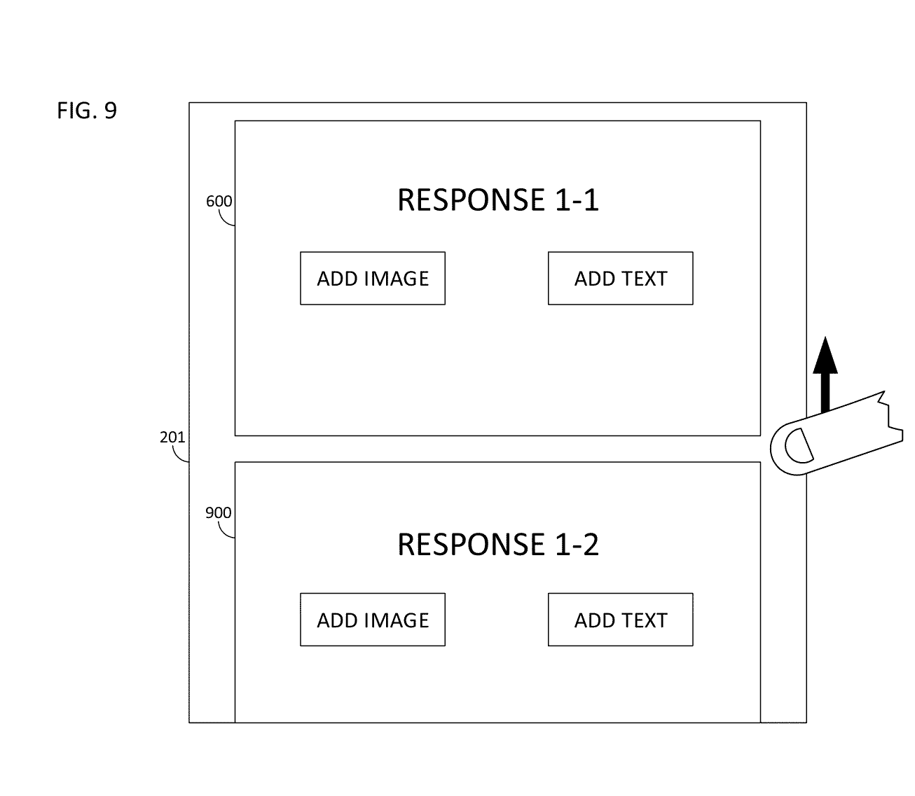

FIG. 9 illustrates an author swiping upward after composing scene response 600 of FIG. 6, resulting in the adaptive content system adding an additional scene response 900. The content or subject matter of scene response 900 may supplement or complement the content of scene response 600, both of which provide further information about the content disclosed in the base scene with which they are associated. An author may also swipe in an opposite direction to display a previous scene response. For example, with respect to FIG. 9, an author may swipe downward while viewing scene response 600 to navigate to and display scene response 900.

Additionally, development module 102 may allow an author to add a scene to a particular response. For example, referring to FIG. 9, instead of adding a response, an author could instead add a scene associated with the displayed response by swiping leftward as described above for scenes with reference to FIG. 4. A series of one or more scenes may be composed and associated with a scene response. Each such scene may in turn have one or more associated scene responses. This progression of scenes and scene responses may be as extensive as the author determines is appropriate.

FIGS. 1-9, discussed above, show how an author may compose guidance content via development module 102. FIG. 10 shows an overview illustration of example guidance content 1000, illustrating how content for the guidance content may be structured to allow users of the guidance content module to select different paths through the guidance content. FIG. 10 illustrates a two dimensional array of guidance content pages configured to provide selectable sequences of access to them by a user. A user of guidance content module 104 may or may not have access to such an overview illustration of guidance content. In some examples, a user may only access guidance content through a title page and then navigate through the guidance content pages using the illustrated options for navigating between the guidance content pages.

Guidance content page 1002 may act as a title page similar to a scene response, for example. Base guidance content pages 1004 may each be part of shared guidance content, or there may be separate guidance content accessed via a base display page. Similar to scenes, such display pages may be composed via content selected via development interface 200.

General or top-level scenes presentable by the guidance content are notated in FIG. 10 as “S₁,” “S₂,” “S₃,” . . . “Sₙ”, where n is a number of sequential scenes that were added by development module 102. In some examples, each scene in a series of scenes may provide progressive information on the general subject matter of the series of scenes as indicated by a base guidance content page. As has been mentioned, each scene in a series of scenes may provide information not included in other scenes of the same series. Scene responses that depend from general scenes and are presentable by the guidance content are notated in FIG. 10 as “SₙR₁,” “SₙR₂,” “SₙR₃,” . . . “SₙR”, where i is a number of sequential scene responses associated with base scene Sₙ. A response scene that depends from a scene response may have a further notation, such as SₙRᵢSₘ. Similarly, a response that depends from a response scene may be indicated by the notation SₙRᵢSₘRⱼ. This layering of information may be extended to as many levels as the author determines is appropriate.

Available paths a user may use to navigate through the guidance content are illustrated in FIG. 10 by lines between display pages. In reference to FIGS. 2-9, corresponding scenes 302 and 400, and scene responses 600 and 900 are illustrative of general scenes and scene responses shown in FIG. 10. Solid line segments in FIG. 10 indicate a navigation path that a user may choose to navigate between adjacent display pages, such as between scenes and/or responses. The title pages may be formed using a scene template or a response template, and may serve as main root guidance content page providing general information about guidance content associated with each title page. FIG. 10 also illustrates direct return routes, shown as dashed lines, which provide shortcuts available for a user to use to return from a response scene to a base scene through which the user navigated to access the response scene.

In addition to the access paths shown, an author may add links or interactive content to a scene to allow a user to navigate directly or “jump” to non-adjacent scenes. Such a non-adjacent navigation is shown in FIG. 10 as arrow 1010 between S₁R₂S₂R₁S₁ and S₂R₂S₂. Added interactive content may be provided by a user text entry field or a list of options selectable by a user, for example. An author may add such links or interactive content via development tools 204 of development interface 200 as shown in FIG. 2. As another example, an author may add text entry queries that may be displayed to a user. For example, response scene S₁R₂S₂R₁S₁ may display to a user a request to enter text information about their experience followed by a blank field where the user can enter his or her comments. Similarly, a response or scene may be configured to provide a query to a user, such as when a particular last response or response scene is viewed, the answer to which may be used to determine if the user understands the content presented to get to a next guidance content page. This information may be used to determine whether the user is ready to proceed to other parts of the guidance content or whether the user will be presented with further information related to the subject matter the user has already viewed. The user may then automatically be presented with such next part, or be asked to enter a user input to confirm that the user chooses to navigate to the next part. Further, an author may desire a user's input about a set of responses to determine whether the responses did not adequately inform the user of the subject matter.

Distribution of composed guidance content to make them available to guidance content module 104 may be provided in various ways. In some examples, the author enters instructions to development module 102 to transfer completed guidance content to a library sector of database 106. For example, an author may conveniently upload guidance content in response to an author input such as clicking a virtual “upload” button. As another example, guidance content may be automatically updated at a desired frequency, in which case it is only necessary to add new guidance content pages to stored guidance content and modify changed guidance content pages to produce a current version accessible by guidance content module 104.

A server for database 106 may be accessed by distribution module 108 to download a current version of a guidance content module. For example, guidance content module 104 may download or otherwise receive particular guidance content selected by a user. For example, an appropriate server is shown in FIG. 12.

In some examples, guidance content module 104 may send usage information to a development segment of database 106. For example, usage information may include time spent on particular scenes or responses. As another example, usage information may include a navigation path taken by users. Usage information may also include text data entered by a user via a text entry box such as text entry box 212 or 214 added from a scene template described with reference to FIG. 2. It will therefore be appreciated that adaptive content system 100 shown in FIG. 1 may include an author-user feedback loop where an author may compose guidance content, a user may use the guidance content, and the guidance content module may provide usage information back to the author. This allows the author to update the plan based on the usage information. This may be accomplished in real time in a sense that the author obtains up-to-date usage information and downloads updated guidance content pages while a user is accessing the guidance content, for example.

In summary, the adaptive content system may be used to compose guidance content that are in turn provided to a user. Further, the adaptive content system may provide feedback of usage information that may be used by an author to make changes to the guidance content.

FIG. 11 illustrates a data processing system 1100 in accordance with aspects of the present disclosure. In this example, data processing system 1100 is an illustrative data processing system for implementing a system for displaying learner-centered media content as discussed above with reference to FIGS. 1a-4.

In this illustrative example, data processing system 1100 includes communications framework 1102. Communications framework 1102 provides communications between processor unit 1104, memory 1106, persistent storage 1108, communications unit 1110, input/output (I/O) unit 1112, and display 1114. Memory 1106, persistent storage 1108, communications unit 1110, input/output (I/O) unit 1112, and display 1114 are examples of resources accessible by processor unit 1104 via communications framework 1102. It is to be understood that display 201 described above may be an example of display 1114 in this illustrative example. Further, any input device described above may be an example of an input/output (I/O) unit 1112.

Processor unit 1104 serves to run instructions for software that may be loaded into memory 1106. Processor unit 1104 may be a number of processors, a multi-processor core, or some other type of processor, depending on the particular implementation. Further, processor unit 1104 may be implemented using a number of heterogeneous processor systems in which a main processor is present with secondary processors on a single chip. As another illustrative example, processor unit 1104 may be a symmetric multi-processor system containing multiple processors of the same type.

Memory 1106 and persistent storage 1108 are examples of storage devices 1116. A storage device is any piece of hardware that is capable of storing information, such as, for example, without limitation, data, program code in functional form, and other suitable information either on a temporary basis or a permanent basis.

Storage devices 1116 also may be referred to as computer readable storage devices in these examples. Memory 1106, in these examples, may be, for example, a random access memory or any other suitable volatile or non-volatile storage device. Persistent storage 1108 may take various forms, depending on the particular implementation.

For example, persistent storage 1108 may contain one or more components or devices. For example, persistent storage 1108 may be a hard drive, a flash memory, a rewritable optical disk, a rewritable magnetic tape, or some combination of the above. The media used by persistent storage 1108 also may be removable. For example, a removable hard drive may be used for persistent storage 1108.

Communications unit 1110, in these examples, provides for communications with other data processing systems or devices. In these examples, communications unit 1110 is a network interface card. Communications unit 1110 may provide communications through the use of either or both physical and wireless communications links.

Input/output (I/O) unit 1112 allows for input and output of data with other devices that may be connected to data processing system 1100. For example, input/output (I/O) unit 1112 may provide a connection for user input through a keyboard, a mouse, and/or some other suitable input device. Further, input/output (I/O) unit 1112 may send output to a printer. Display 1114 provides a mechanism to display information to a user. Input and output devices may be combined, as is the case for a touch-screen display.

Instructions for the operating system, applications, and/or programs may be located in storage devices 1116, which are in communication with processor unit 1104 through communications framework 1102. In these illustrative examples, the instructions are in a functional form on persistent storage 1108. These instructions may be loaded into memory 1106 for execution by processor unit 1104. The processes of the different embodiments may be performed by processor unit 1104 using computer-implemented instructions, which may be located in a memory, such as memory 1106.

These instructions are referred to as program instructions, program code, computer usable program code, or computer readable program code that may be read and executed by a processor in processor unit 1104. The program code in the different embodiments may be embodied on different physical or computer readable storage media, such as memory 1106 or persistent storage 1108.

Program code 1118 may also be located in a functional form on computer readable media 1120 that is selectively removable and may be loaded onto or transferred to data processing system 1100 for execution by processor unit 1104. Program code 1118 and computer readable media 1120 form computer program product 1122 in these examples. In one example, computer readable media 1120 may be computer readable storage media 1124 or computer readable signal media 1126. It is to be understood that the guidance system discussed above may include program code stored on a storage device 1116 or be included on computer program product 1122, program code 1118, computer readable media 1124, or computer readable signal media 720.

Computer readable storage media 1124 may include, for example, an optical or magnetic disk that is inserted or placed into a drive or other device that is part of persistent storage 1108 for transfer onto a storage device, such as a hard drive, that is part of persistent storage 1108. Computer readable storage media 1124 also may take the form of a persistent storage, such as a hard drive, a thumb drive, or a flash memory, that is connected to data processing system 1100. In some instances, computer readable storage media 1124 may not be removable from data processing system 1100.

In these examples, computer readable storage media 1124 is a physical or tangible storage device used to store program code 1118 rather than a medium that propagates or transmits program code 1118. Computer readable storage media 1124 is also referred to as a computer readable tangible storage device or a computer readable physical storage device. In other words, computer readable storage media 1124 is a media that can be touched by a person.

Alternatively, program code 1118 may be transferred to data processing system 1100 using computer readable signal media 1126. Computer readable signal media 1126 may be, for example, a propagated data signal containing program code 1118. For example, computer readable signal media 1126 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 1118 may be downloaded over a network to persistent storage 1108 from another device or data processing system through computer readable signal media 1126 for use within data processing system 1100. For instance, program code stored in a computer readable storage medium in a server data processing system may be downloaded over a network from the server to data processing system 1100. The data processing system providing program code 1118 may be a server computer, a client computer, or some other device capable of storing and transmitting program code 1118.

The different components illustrated for data processing system 1100 are not meant to provide architectural limitations to the manner in which different embodiments may be implemented. The different illustrative embodiments may be implemented in a data processing system including components in addition to and/or in place of those illustrated for data processing system 1100. Other components shown in FIG. 11 can be varied from the illustrative examples shown. The different embodiments may be implemented using any hardware device or system capable of running program code. As one example, data processing system 1100 may include organic components integrated with inorganic components and/or may be comprised entirely of organic components excluding a human being. For example, a storage device may be comprised of an organic semiconductor.

In another illustrative example, processor unit 1104 may take the form of a hardware unit that has circuits that are manufactured or configured for a particular use. This type of hardware may perform operations without needing program code to be loaded into a memory from a storage device to be configured to perform the operations.

For example, when processor unit 1104 takes the form of a hardware unit, processor unit 1104 may be a circuit system, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices include, for example, a programmable logic array, a programmable array logic, a field programmable logic array, a field programmable gate array, and other suitable hardware devices. With this type of implementation, program code 1118 may be omitted, because the processes for the different embodiments are implemented in a hardware unit.

In still another illustrative example, processor unit 1104 may be implemented using a combination of processors found in computers and hardware units. Processor unit 1104 may have a number of hardware units and a number of processors that are configured to run program code 1118. With this depicted example, some of the processes may be implemented in the number of hardware units, while other processes may be implemented in the number of processors.

In another example, a bus system may be used to implement communications framework 1102 and may be comprised of one or more buses, such as a system bus or an input/output bus. Of course, the bus system may be implemented using any suitable type of architecture that provides for a transfer of data between different components or devices attached to the bus system.

Additionally, communications unit 1110 may include a number of devices that transmit data, receive data, or both transmit and receive data. Communications unit 1110 may be, for example, a modem or a network adapter, two network adapters, or some combination thereof. Further, a memory may be, for example, memory 1106, or a cache, such as that found in an interface and memory controller hub that may be present in communications framework 1102.

The flowcharts and block diagrams described herein illustrate the architecture, functionality, and operation of possible implementations of systems, methods, and computer program products according to various illustrative embodiments. In this regard, each block in the flowcharts or block diagrams may represent a module, segment, or portion of code, which comprises one or more executable instructions for implementing the specified logical function or functions. It should also be noted that, in some alternative implementations, the functions noted in a block may occur out of the order noted in the figures. For example, the functions of two blocks shown in succession may be executed substantially concurrently, or the functions of the blocks may sometimes be executed in the reverse order, depending upon the functionality involved.

FIG. 12 describes a network data processing system 1200 in which illustrative embodiments may be implemented. It should be appreciated that FIG. 12 is provided as an illustration of one implementation and is not intended to imply any limitation with regard to environments in which different embodiments may be implemented. Many modifications to the depicted environment may be made.

Network data processing system 1200 is a network of computers in which one or more illustrative embodiments of a system for displaying learner-centered media content may be implemented. Network data processing system 1200 may include network 1202, which is a medium configured to provide communications links between various devices and computers connected together within network data processing system 1200. Network 1202 may include connections such as wired or wireless communication links, fiber optic cables, and/or any other suitable medium for transmitting and/or communicating data between network devices, or any combination thereof.

In the depicted example, a first network device 1204 and a second network device 1206 connect to network 1202, as does a electronic storage device 1208. In the depicted example, devices 1204 and 1206 are shown as server computers. However, network devices may include, without limitation, one or more routers, switches, voice gates, servers, electronic storage devices, imaging devices, and/or other networked-enabled tools that may perform a mechanical or other function. These network devices may be interconnected through wired, wireless, optical, and other appropriate communication links.

In addition, client electronic devices 1210, 1212, and 1214 connect to network 1202. Client electronic devices 1210, 1212, and 1214 may include, for example, one or more personal computers, network computers, and/or mobile computing devices such as personal digital assistants (PDAs), smart phones, handheld gaming devices, wearable devices, and/or tablet computers, and the like. In the depicted example, server 1204 provides information, such as boot files, operating system images, and applications to one or more of client electronic devices 1210, 1212, and 1214. Client electronic devices 1210, 1212, and 1214 may be referred to as “clients” with respect to a server such as server computer 1204. In some examples, one or more of electronic devices 1210, 1212, and 1214 may be stand-alone devices corresponding to data processing system 1100. Network data processing system 1200 may include more or fewer servers and clients, as well as other devices not shown.

Program code located in system 1200 may be stored in or on a computer recordable storage medium and downloaded to a data processing system or other device for use. For example, program code may be stored on a computer recordable storage medium on server computer 1204 and downloaded to client 1210 over network 1202 for use on client 1210.

Network data processing system 1200 may be implemented as one or more of a number of different types of networks. For example, system 1200 may include an intranet, a local area network (LAN), a wide area network (WAN), or a personal area network (PAN). In some examples, network data processing system 1200 includes the Internet, with network 1202 representing a worldwide collection of networks and gateways that use the transmission control protocol/Internet protocol (TCP/IP) suite of protocols to communicate with one another. At the heart of the Internet is a backbone of high-speed data communication lines between major nodes or host computers. Thousands of commercial, governmental, educational and other computer systems may be utilized to route data and messages. FIG. Y is intended as an example, and not as an architectural limitation for any illustrative embodiments.

### Discussion

The example of the adaptive content system described above provides a closed-loop system for the creation and distribution that may incorporate robust data collection, analysis and reporting, enabling guidance content, such as user Guides, to rapidly evolve to ever higher levels of effectiveness over a very short period of time. With use by a population with varying levels of prior knowledge, experience and expertise, electronic user guides, as envisioned in the claimed technology, can rapidly evolve to approach 6 sigma levels of effectiveness across a wide range of users.

User guides (owner manuals, operating instructions, process instructions, etc.) are useful to understanding and being able to more effectively use or apply a wide range of products, services, processes and procedures. Existing user guides are often a result of choosing a medium or media, creating the user guide and distributing same. Periodic reviews and user feedback (generally anecdotal in nature) are used to update user guides on either a scheduled or ad hoc basis. As such, they were not designed as an overall system of distribution, feedback, evolution and re-distribution. The processes and procedures that do exist to update user guides do not necessarily keep pace with changes in the products, services, processes and procedures they are intended to support.

The adaptive content system provides a closed-loop system for creating, distributing and rapidly evolving user guides.

### GLOSSARY OF TERMS

Scene—A basic building block of the adaptive content system. An individual bit of information or instruction. It may consist, but is not limited to any of the following, alone or in various combinations of Media (Images, Video, Text, Animations, Forms, Quizzes, etc.), Narrative Text, and Audio (Speech, Sounds, Music).

Response—A selection made from a scene that may be associated with additional scenes to expand upon or clarify the original or base scene

User—Any person (customer, employee, supplier, vendor, etc.) employing a user guide.

Producer—A person or organization that develops, distributes and maintains (updates) a user guide

Expert/Author—A person or group of that collectively have the most complete understanding of the product, service, process or procedure, are able to effectively communicate, and are the creators of a user guide.

The claimed technology consists of 4 subsystems integrated into a single closed-loop system.
User Guide Creator (Creator)
User Center (Distribution)
User Guide Database (Data Storage and Analysis)
User Guide Player (Player)

The User Guide Creator or development module application may allow a person working alone or persons working as a team to create electronic user guides. The user guide steps the user through a sequence of scenes. The scenes may be configured to allow the user, through the selection of responses or choices, to modify the sequence of scenes to receive information of a type and at the level of detail they may need or want to understand and successfully apply the information.

Several features/capabilities may be provided:

1. Scenes, responses and choices may all be modular. Each can be rapidly (in a matter of minutes) edited or replaced in whole or in part without affecting the integrity of a user guide.

2. New or additional scenes, responses or choices can be rapidly created and inserted into existing user guides with relative ease.

3. An option for a user to provide feedback may be made an integral part of any scene or response.

4. With use, user feedback can be generated and provided to experts for creating better user guides.

In context of an overall system, an aspect of the described user guide creator is an ability to systematically and rapidly make changes. Producers of user guides may make changes/updates to user guides in a matter of minutes to a few hours. This stands in stark contrast to videos or slide presentations (both automated and non-automated), websites and other, “legacy approaches”, that typically take much longer to update. As an aside, videos typically take 6 to 8 weeks to update, slide presentation instructions 2-4 weeks and websites weeks to months, because they are inherently linear presentations of information, and not modular. Thus, careful consideration must be given to any changes because of the probability of unintended consequences and the lengthy cycle time to identify and correct same. The user center may be a distribution and data hub. The user center may be the location where published user guides that have been released for distribution reside. User guides may be published to public space (public collection) or to one of any number of private spaces (private collections). The distribution of user guides published to private collections may be controlled by the publisher.

The user center also may serve as a coordination center to form and manage teams to create user guides and to coordinate the activities of team members. In a preferred embodiment, team members can be assigned specific roles within the creation, review, approval and publishing process. In a preferred embodiment, voice and/or text chat capabilities are provided for team coordination purposes.

The user guide database may provide standard functions generally associated with storing account information, user guides, media elements used in the user guides, etc. As it relates to the claimed technology, the database may provide two capabilities to the system. First, the database may collect and collate user feedback. Users may be able to note problems and provide feedback, such as at every scene in a user guide sequence. In this example, feedback is converted from what is generally an ancillary user activity to one that is integral and indexed to specific steps in the process.

Second, the database may collect and collate detailed audit trails of each usage of a user guide. Date/time stamps may be created at a beginning and end of each step accessed by a user. That data may be used to establish a time-sequenced audit trail of each use. Collated and summarized audit trail data may provide a statistical mapping of sequences through a user guide. In a preferred embodiment, data/time stamps mark the beginning and end of each step accessed by a user in a sequence. This may provide not only a statistical map of usage, but also a picture of where users are spending their time within a sequence of scenes, responses and choices. Together, these may provide insight into those portions of a user guide that are effective, those that users find problematic, and even those that could be simplified to reduce the time required without losing overall effectiveness. These capabilities change user guides from what is today largely based on surveys and anecdotes into a more evolved, closed loop improvement system based on statistics and comprehensive usage data.

The user guide player may transform flow of information from a presentation-based, sending (push) of information to a user-initiated, pulling of information. With legacy approaches, users are presented with information in sequence, with a type of media and at a level of specificity (detail) that the producer of the presentation (video or other) feels is appropriate. In such legacy approaches, a user is relegated to being a passive viewer of the information. In some cases legacy approaches have been augmented with various forms of supplementary info capabilities such as linked Q&A's, hotspot links to added information, videos within videos, etc. Lacking an underlying structure to make user navigation intuitive, these augmentations of legacy approaches are limited in scope in that a user merely selects and receives information in a linear fashion making it technically challenging to create efficient and effective presentations.

In the adaptive content system described above, a user may be given a wide variety of information options at each step in a guidance content. These options can include presentation of the same information in different forms, where the same information at different levels of detail and mediums may be provided to a user automatically or upon request. As such, access to explanatory or supplemental information regarding the specifics contained in the information being presented is possible. A user may choose information they wish to receive in a way they wish to receive it. This changes a user's role from passive to active and from viewer to protagonist. Most importantly, it is a user who determines when they have a sufficient understanding of the information at any given point, to proceed to the next and then how they wish to proceed.

The user guide player or guidance content module may be designed to enable a user to navigate what can be numerous possible sequences, without getting confused or lost. Associated with this is the concept that as a user accesses responses, a reference to a scene from which the user departed from may be retained. Thus, no matter how many levels of scenes and responses have been accessed, the path to return to the original point of departure is provided to the user.

As discussed above with respect to the User Guide Database, as a user accesses information each scene and response may be date/time stamped. In a preferred embodiment, the beginning and end of each scene and response accessed is date and/or time stamped. This provides an accurate audit trail. Alternatively, just a beginning (access) or end (departure) for each scene could be date and/or time stamped and an approximation of time spent derived through subtraction can be obtained by the system. This provides a very accurate accounting of what has transpired. To add context and clarification regarding reasons a user has choosing a particular path, the User Guide Player may offer an opportunity for each user to comment on any or all scenes. While commenting is voluntary, over time, many users and many uses of a user guide, context and clarification may be added to the audit trail data, thereby enabling the producers of the user guide to make targeted changes to the user guide.

The described technology may incorporates principles of a closed loop continuous improvement process with creation, distribution, use and evaluation of user guides. This approach may eliminate barriers that may otherwise obviate the ability of such a system to operate.

The described system may provide the conveying of information to a user of a product, service, process, or procedure via an electronic user guide. When a user lacks sufficient knowledge or expertise to successfully use a product or service, or to successfully complete a process or procedure, an effective method of assisting the user, while at the same time conveying an understanding of the same, so that the user can become more self-reliant, may be for a subject matter expert and skilled communicator (expert), acting a personal tutor, to guide the user step by step through to a successful outcome. In this process, the expert actively engages with and mentors the user by prompting the user to ask questions, and having the user answer the expert's questions. This may transform the communication from an expert-centered sending (one-way presentation) of information to a user-centered acquisition (two-way exchange) of information in a way and at the level of detail that both facilitates successful completion of the task the first time and increases the user's knowledge and expertise enabling the user to become more self-sufficient in the future.

In all but the most exceptional situations, providing an expert as a personal tutor who is available whenever and wherever needed by any and all users is impossible or impractical. User guides in various forms have been created in an effort to provide users with necessary information they need to successfully use products or services, or to successfully complete processes or procedures. Lacking a better platform, user guides have primarily been linear presentations from the expert's perspective, relegating the user to being a passive observer. Personal tutoring otherwise has been too difficult and costly to be of practical use.

The system may provide for creating electronic user guides that closely emulate the aforementioned user-centered acquisition of information through mentoring by an expert personal tutor.

A first scene may be a first bit of expert-provided information to start the aforementioned user-centered communication. When creating the first scene and every scene thereafter, the expert may be challenged to consider the information presented from the perspective of the overall user population and, based on their knowledge of and experience with users, to provide the users with responses and choices by which each user may then guide the sequence of information.

If a scene contains content (words, concepts, images, etc.) that some users may not understand, may need to have communicated in a different way, or that they may wish to explore in more detail before proceeding to the next scene, the expert may append responses to that scene. Responses appended to a scene may be accessed in any of a variety of ways. In a preferred embodiment, responses are accessed by swiping the associated scene up to reveal a first response that is below that scene, swiping up again reveals the second response, and so on. An alternative is to provide some form of menu with the associated scene to allow the user to access selectively the appended responses. For each response, scenes may be created to provide information in sequences to satisfy the user's need for additional information. As before, if the expert feels that the scene may contain content (words, concepts, images, etc.) that some users may not understand, may need to have communicated in a different way, or that they may wish to explore in more detail before proceeding to a next scene, the expert may append these to the scene as responses. This process of scenes being appended with responses that lead to further scenes that may be appended with responses is repeated as necessary until the communicator or expert, based on their knowledge of and experience with a target user population is satisfied that each user will be able to guide the communication onward with a sufficient understanding and ability to apply the information being conveyed. For example, an expert may provide guidance to a user in a way that allows a user to determine when the user is ready to choose a direction to proceed.

In some cases, when a user is ready to proceed, they simply move to the next scene. In a preferred embodiment this is accomplished by swiping from right to left to reveal the next scene. In some cases, the user may be presented choices or options. One type of choice is to select a path forward from among multiple paths. For example, a user may choose a model of a product a user has from among different models of the product via such provided options or choices. A second type of choice is to choose to proceed to a new section, skipping sections of information that may be redundant or undesirable to a user's understanding. In a preferred embodiment, choices are presented as a type of media in a scene.

In this way a logically complex, multi-dimensional array of scenes, responses and choices can be created and used with ease.

In a further example, the adaptive content system may maintain a relationship between a scene from which a user departed (point of origin) and a sequence of responses and scenes that follow. The expert can create a myriad of response-to-scene-to-response sequences for the user. This differs greatly from current technologies that, in general, provide very limited question and response capabilities. As is the case in a one-on-one communication of information, once the user is satisfied that they sufficiently understand the information, or have satisfied their curiosity regarding related information and decide to proceed, the communication returns to a local point of origin and continues onward from such point. Swiping down to reveal the scene above returns a user to a proximate point of origin.

User guides can be created on a variety of devices including smart phones, tablets and computers and be used as mobile web applications or device-specific, “native” applications via those same devices. To create a user guide, an expert may start by constructing a scene. A representation of the structure of a scene may be presented to the expert via a user guide creation application. The expert may create a scene by inserting some or all of the possible scene components such as media, narrative text, or audio.

As has been mentioned, a detailed audit trail of scenes and responses accessed, time spent on each scene and response, choices made and answers to questions (quizzes) may be collected and automatically sent to a database. These audit trails can be used to document user understanding and agreement, for compliance purposes, and to obviate potential liability issues. Additionally, analysis of aggregate use data may provide experts with information regarding changes, additions or deletions that may be made to a user guide.

The described adaptive content system may allow experts to create electronic user guides that closely emulate person-to-person interaction of an expert providing personalized assistance to a user. The application and value of such a method and system may not be limited to just user guides. Emulating person-to-person interaction has application in education, storytelling, and social media. The adaptive content system, thus, may provide a new medium for creating and sharing a user-centered and guided/directed information flow to enable task success. In the same way that PowerPoint™ and Keynote™ applications reinvented overhead presentations, the adaptive content system may be used to reinvent the mentor-to-apprentice approach to task success.

The adaptive content system may be used to promote and seek to assure first time successful accomplishment of a task or objective. User-centered methodology may enable users with widely varying levels of prior knowledge and experience to be successful in completing a task a first time and every time. As such, the adaptive content system may allow a user to complete tasks efficiently and effectively without requiring the user to be completely trained in knowledge required to complete the task without the proposed adaptive content system. For example, the adaptive content system may allow a user to complete a task of fixing a car engine via steps and guidance without the user having to be fully educated or trained in mechanics. Using the present adaptive content system, the user fixing a car engine may be guided to task completion without any formal, traditional linear education, such as education provided by most colleges.

As such, the adaptive content system may allow completion of tasks by means of providing the user with the ability to choose only as much information as the user requires to complete the task, without requiring the user to master general skills. This can be termed cognitive apprenticeship, where a mentor provides as much information as an apprentice needs to be successful. Over time, learning may occur, and the amount of required mentoring decreases, eventually resulting in the apprentice mastering the subject, skill or task.

Existing approaches teach users about a subject, task or skill in the hope that the user will be able to apply what is taught to a specific situation. However, the present adaptive content system may configure guidance content to individually assist a user to be successful in completing a task. Knowledge or understanding may come as a byproduct of success, but is not a prerequisite. Structurally, an expert creating such aforementioned user guides may be able to construct a myriad of likely paths that different users may take to achieve task success in a way that does not force users to follow paths they do not need or cannot benefit from. Existing approaches do not have such ability.

Flexibility and adaptability of the present adaptive content system may allow better and more efficient task accomplishment compared to one-size-fits-all instruction. For example, the adaptive content system may allow a user to solve a Rubik's Cube more efficiently than a standard YouTube video about solving Rubik's Cubes. As such, a one-size-fits-all presentation or user guide would not achieve a same success rate as a path-selectable or path-navigable guide provided by the present adaptive content system.

If a user desires to accomplish something with respect to a subject, task, skill, process or procedure, a first challenge for any medium is to determine the user's objective. The present adaptive content system inherently has access to the user's objective by letting the user choose, from a set of options, a desired path in a guidance content. Legacy approaches merely provide an index or the like. Information that any particular user may need is based on their prior knowledge, prior experience and the context of their use. The present adaptive content system may be used to compose guidance content that uses knowledge of the user's prior experience. Different people absorb information differently. Some people will resonate well with pictures, others with text and still others are audio learners. As such, users of guidance content appropriately composed using the present adaptive content system may choose paths that work well for their learning styles, even if the users are not aware of such media distinctions. Social constructivists call this situational learning or contextual learning and it is one of the fundamental concepts in cognitive apprenticeship as described above.

An expert may provide a user with checkpoints where the user may confirm that they are ready to move on. Via queries, the adaptive content system may learn that a user is not ready to move on. If the user does not understand the presented information, or the user guide does not deem the user ready to move on, it could be that the user needs to see a proper sequence demonstrated in a different media format, or a different storytelling style. For example, the user may need to see information sequences broken down into smaller increments with greater detail, it could be that there is an underlying concept they are missing and need remedial instruction on that point, or it could be that they need a combination of media constructs.

Existing legacy approaches commonly provide “initial training” to ultimately hope a user will complete a task or learn a subject. The adaptive content system may be used to start on the other end with “on-demand assistance.” Such “on-demand assistance” is described by Dr. Engyvig in “Full Spectrum Knowledge Sharing”. The present adaptive content system provides on-demand assistance based on user inputs.

### CONCLUSION

The disclosure set forth above may encompass multiple distinct inventions with independent utility. Although each of these inventions has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only, and do not constitute a characterization of any claimed invention. The subject matter of the invention(s) includes all novel and nonobvious combinations and subcombinations of the various elements, features, functions, and/or properties disclosed herein. The following claims particularly point out certain combinations and subcombinations regarded as novel and nonobvious. Invention(s) embodied in other combinations and subcombinations of features, functions, elements, and/or properties may be claimed in applications claiming priority from this or a related application. Such claims, whether directed to a different invention or to the same invention, and whether broader, narrower, equal, or different in scope to the original claims, also are regarded as included within the subject matter of the invention(s) of the present disclosure.

We claim:

1. An adaptive content system comprising:
a storage system including at least one storage device, the storage system storing at least one unpopulated content unit having selectable fields configured to receive information content presentable in a form sensible to a user and being configured to receive sequence links to at least one other content unit, and at least one content collection, each content collection including a plurality of populated content units with each populated content unit containing information content and at least one sequence link selectable by a user for establishing a sequence in which the content units are presented to a user;
a development module configured to access the storage system to retrieve a copy of the at least one unpopulated content unit, to populate the copy of the at least one unpopulated content unit with information content received from an author on at least one development input device, to retrieve a populated content unit selected by the author, to modify the information content in the selected populated content unit in response to commands received on the at least one development input device, and to store populated content units on the storage system; and
a presentation module configured to access the storage system to retrieve the at least one content collection of content units, to present on at least one presentation output device content units sequentially in response to inputs received from at least one user-operated presentation input device, and to present on the at least one output device information content from the presented content units in response to inputs received from the at least one user-operated presentation input device without allowing modification of the information content populated on the content units.
